(19) United States
(12) Patent Application Publication
(10) Pub. No.: US 2023/0080301 A1
(43) Pub. Date: Mar. 16, 2023

(54) METHOD FOR DETERMINING A POSITION OF A HOLDING AREA FOR A VEHICLE AND FOR A POTENTIAL PASSENGER OF THE VEHICLE

(71) Applicant: Robert Bosch GmbH, Stuttgart (DE)

(72) Inventors: Henning Hoepfner, Renningen (DE); Tobias Meilinger, Tuebingen (DE)

(21) Appl. No.: 17/942,720

(22) Filed: Sep. 12, 2022

(30) Foreign Application Priority Data
Sep. 16, 2021 (DE) 102021210264.6

(51) Int. Cl. G01C 21/34

(52) U.S. Cl. CPC G01C 21/3438; G06V 20/56

(57) ABSTRACT

A method is provided for ascertaining with the aid of a local ascertainment device a position of a stopping area for a vehicle and for a potential passenger of the vehicle as a meeting point of the vehicle with the potential passenger. The method includes observing and modeling surroundings of the local ascertainment device, receiving pieces of information of the vehicle via a wireless communication, receiving pieces of information of the potential passenger via a wireless communication from an electronic mobile device of the potential passenger, ascertaining a position of the stopping area for the vehicle and for the potential passenger of the vehicle as a function of the surroundings of the local ascertainment device and the pieces of information of the vehicle and of the potential passenger, conveying the position of the stopping area to the vehicle and to the electronic mobile device of the potential passenger.

### BACKGROUND INFORMATION

A system and a method for vehicle ridesharing and vehicle ridesharing management are described in U.S. Patent Application Publication NO. US 2019/311307 A1.

### SUMMARY

According to an example embodiment of the present invention, a method is provided for ascertaining with the aid of a local ascertainment device a position of a stopping area for a vehicle and for a potential passenger of the vehicle as a meeting point of the vehicle with the potential passenger, including the following steps,

observing and modeling surroundings of the local ascertainment device,

receiving pieces of information of the vehicle via a wireless communication,

receiving pieces of information of the potential passenger via a wireless communication, in particular, from an electronic mobile device of the potential passenger,

ascertaining a position of the stopping area for the vehicle and for the potential passenger of the vehicle as a function of the surroundings of the local ascertainment device and of the pieces of information of the vehicle and of the pieces of information of the potential passenger,

conveying the position of the stopping area to the vehicle and to the potential passenger, in particular, to the electronic mobile device of the potential passenger.

An advantage of the provided method according to the present invention is that a vehicle and a potential passenger find one another faster and more reliably. In this case, a vehicle may, in particular, be driven by a driver or may be autonomously or semi-autonomously controlled. The vehicle may, for example, be designed as a transport vehicle for transporting riders. The potential passenger may also be referred to as a potential rider. With the aid of the provided method, it is advantageously possible to facilitate and thus ensure the mutual finding of the vehicle and of the potential passenger, which is to be transported by the vehicle. This may advantageously enable a more rapid handling of the process of finding the vehicle and the rider and/or of the process of the rider entering the vehicle. As a result, the vehicle may, in particular, be provided more quickly for other possible further riders, which increases, in particular, the availability of the vehicles as means of transportation. Furthermore, costs may be saved as a result. One further advantage of the provided method is that the space, which is limited, in particular, in large cities, may be optimally utilized for ascertaining a meeting point of the vehicle with the potential passenger. The more rapid handling of the meeting may increase, in particular, the comfort of the passenger and/or of the driver.

In one exemplary embodiment of the present invention, the step of observing and modeling the surroundings of the local ascertainment device is carried out with the aid of an observation device of the local ascertainment device. In one further development of the present invention, the observation device may be designed, in particular, as a camera. This may enable an optimal observation of the surroundings of the local ascertainment device, which may, as a result, enable a modeling of the surroundings. As a result, it is possible to identify or recognize buildings, vehicles, other persons or further objects in the surroundings of the local ascertainment device, in particular, in a safe and/or reliable manner.

According to an example embodiment of the present invention, the method may advantageously further include a step of representing the ascertained stop as an image with the aid of a display device of the local ascertainment device. As a result, a potential passenger and/or the driver of a vehicle may be shown the potential stop or the position of the stopping area in a safe and/or reliable manner. A rapid meeting of the potential passenger and of the vehicle may be advantageously enabled. This may enhance, in particular, the comfort of the potential passenger and/or of the driver of the vehicle when the vehicle is operated manually.

According to the present invention, the method may further include, in one further development, a step of representing the ascertained stop as an image and/or the ascertained stop as a virtual display of the vehicle and/or navigation directions to the ascertained stop with the aid of a display device of the vehicle for a driver of the vehicle. As a result, when the vehicle is operated manually, a driver may be shown the ascertained stop, in particular, in a safe and/or reliable manner. As a result, the driver may be more rapidly and/or reliably directed to and thus arrive at the position of the stopping area. This may enhance, in particular, the comfort of the driver, since the driver arrives sooner at the stop, and/or of the potential passenger, since the passenger meets the vehicle sooner.

In one exemplary embodiment of the present invention, the method may include a step of representing the ascertained stop as an image and/or the ascertained stop as a virtual display and/or navigation directions to the ascertained stop with the aid of a display device of the electronic mobile device of the potential passenger. As a result, a potential passenger may be shown the ascertained stop, in particular, in a safe and reliable manner. As a result, the potential passenger may be more rapidly and/or reliably directed to and thus arrive at the position of the stopping area. This may enhance, in particular, the comfort of the potential passenger, since the passenger arrives sooner at the stop, and/or of the driver, since the driver meets the potential passenger sooner.

In one advantageous embodiment of the present invention, pieces of information about a position and/or a route and/or a final destination and/or an identification of the vehicle may be received in the step of receiving pieces of information of the vehicle via a wireless communication. In addition or alternatively, in one advantageous embodiment, pieces of information about a position and/or a route and/or a final destination and/or an identification of the potential passenger may be received in the step of receiving pieces of information of the potential passenger via a wireless communication from an electronic mobile device of the potential passenger. As a result, pieces of information about the potential passenger and the vehicle may be conveyed and collected, in particular, in a safe and/or reliable manner, as a result of which, in particular, a reliable and/or rapid ascertainment of a potential stopping area and meeting of the two may be enabled.

In one further development of the present invention, pieces of information about the wireless communication between the ascertainment device and the vehicle and/or between the ascertainment device and the electronic mobile device of the potential passenger may be sent and/or received via WLAN. This may enable, in particular, a safe and/or reliable forwarding of pieces of information between the vehicle, the ascertainment device and/or the mobile terminal of the potential passenger.

According to an example embodiment of the present invention, a local ascertainment device is further provided, which is configured to carry out the method for ascertaining with the aid of a local ascertainment device a position of a stopping area for a vehicle and for a potential passenger of the vehicle as a meeting point of the vehicle with the potential passenger. With the aid of the local ascertainment device, it is advantageously possible to more safely and/or more reliably enable a meeting of a vehicle and of a potential passenger of the vehicle. A situation or the area, which is suitable as a potential stopping area, may advantageously be, in particular, more easily surveyed. As a result, it is possible to facilitate and thus ensure the mutual finding of the vehicle and of the potential passenger, which is to be transported by the vehicle. This may advantageously enable a more rapid handling of the process of finding the vehicle and the rider and/or of the process of the rider entering the vehicle, as a result of which, the vehicle may, in particular, be provided more quickly for other possible further riders. Thus, costs, in particular, may be saved.

According to an example embodiment of the present invention, a device is further provided, in particular, in a vehicle, the device sending pieces of information of the vehicle via a wireless communication to a local ascertainment device, the device receiving pieces of information from the local ascertainment device about a position of a stopping area for the vehicle and about a potential passenger of the vehicle as a meeting point of the vehicle with the potential passenger. As a result, it is possible to enable, in particular, a safe and/or reliable forwarding of pieces of information between the vehicle and the ascertainment device.

In one further development of the present invention, the device may include a display unit, the display unit being designed to represent the ascertained stop as an image and/or the ascertained stop as a virtual display and/or navigation directions to the ascertained stop of the vehicle for a driver of the vehicle. As a result, a driver may be shown the ascertained stop, in particular, in a safe and/or reliable manner, and the driver may be more rapidly and/or reliably directed to the position of the stopping area. This may enhance, in particular, the comfort of the driver and/or of the potential passenger.

According to an example embodiment of the present invention, an electronic mobile device of a potential passenger is further provided, the electronic mobile device sending pieces of information of the potential passenger via a wireless communication to a local ascertainment device, the electronic mobile device receiving pieces of information from the local ascertainment device about a position of a stopping area for the vehicle and for the potential passenger of the vehicle as a meeting point of the vehicle with the potential passenger. This may ensure, in particular, a safe and/or reliable forwarding of pieces of information between the ascertainment device and the mobile terminal of the potential passenger.

In one further development of the present invention, the electronic mobile device may include a display unit, the display unit being designed for representing the ascertained stop as an image and/or the ascertained stop as a virtual display and/or navigation directions to the ascertained stop for the potential passenger of the vehicle. As a result, a potential passenger may be shown the ascertained stop, in particular, in a safe and/or reliable manner, and the potential passenger may be more rapidly and/or reliably directed to the position of the stopping area. This may enhance, in particular, the comfort of the potential passenger and/or of the driver, since the potential passenger arrives, in particular, sooner at the stop.

According to an example embodiment of the present invention, a system is further provided for ascertaining a position of a stopping area for a vehicle and for a potential passenger of the vehicle as a meeting point of the vehicle with the potential passenger, a local ascertainment device and an electronic mobile device.

### BRIEF DESCRIPTION OF THE DRAWINGS

Exemplary embodiments of the present invention are represented in the figures and explained in greater detail in the following description. Identical reference numerals are used for elements which are represented in the various figures and act similarly, a repeated description of these elements being omitted.

FIG. 1 schematically shows a representation of a method according to one exemplary embodiment of the present invention.

FIG. 2 schematically shows a representation of a method according to one exemplary embodiment of the present invention.

FIG. 3 schematically shows a representation of a system according to one exemplary embodiment of the present invention.

FIG. 4 schematically shows a representation of a stopping area according to one exemplary embodiment of the present invention.

### DETAILED DESCRIPTION OF EXAMPLE EMBODIMENTS

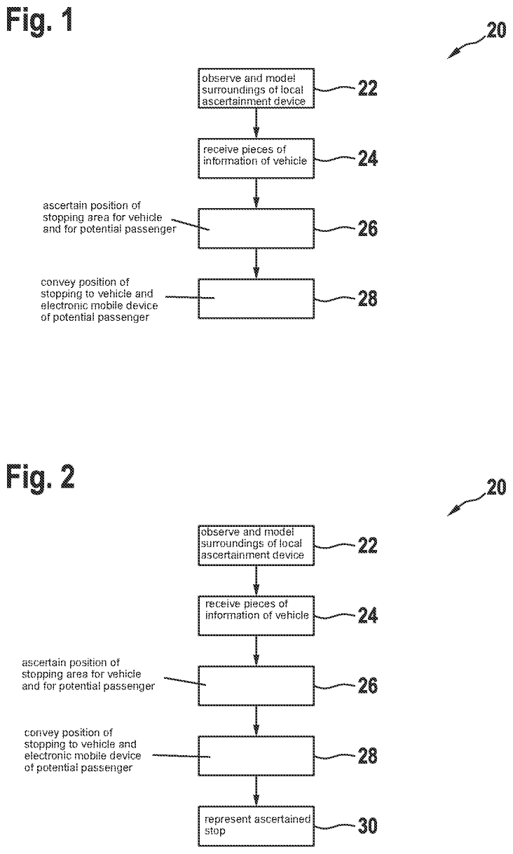

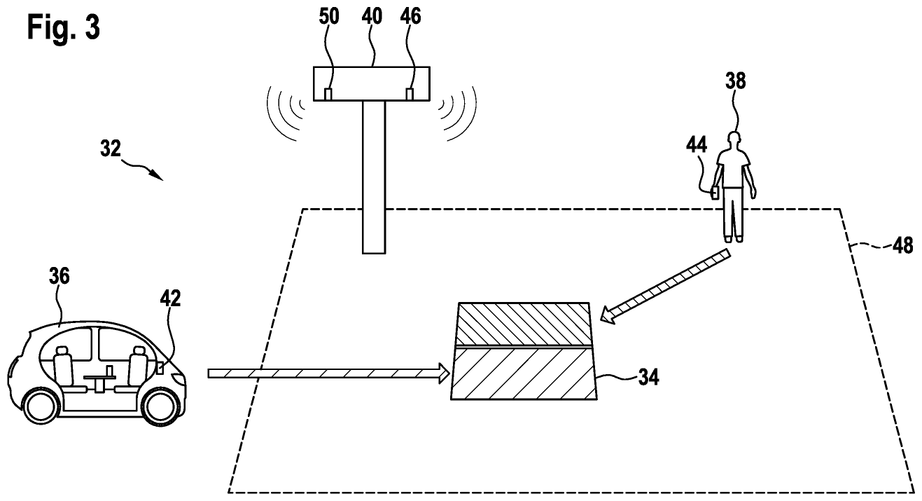

FIG. 1 schematically shows a representation of a method 20 for ascertaining a position of a stopping area for a vehicle and for a potential passenger of the vehicle as a meeting point of the vehicle with the potential passenger according to one exemplary embodiment of the present invention. Method 20 may be carried out with the aid of a local ascertainment device, in particular, according to the local ascertainment device according to FIG. 3. The local ascertainment device may also be referred to as a stop pillar.

The vehicle may be used, for example, as a means of transportation for a potential passenger. In other words, a potential passenger wishes to be transported with the vehicle and thus brought to a particular final destination. For this purpose, the vehicle may, for example, be steered manually by a driver. In one alternative embodiment, the vehicle may be designed as an autonomously driving vehicle. For example, a potential passenger may book a trip with the means of transportation or the vehicle and may thus be brought to a final destination. For this purpose, the potential passenger must, in particular, enter the vehicle. For this purpose, a meeting point of the vehicle with the potential passenger, in particular, must be arranged. The meeting point of the vehicle with the potential passenger may be ascertained, for example, with the aid of the method per se.

In a first step 22 of method 20, surroundings of the local ascertainment device are observed and modeled. For observing the surroundings, the local ascertainment device may include, in particular, an observation device. In other words, the surroundings may be observed with the aid of an observation device. The observation device may include, for example, a camera or may be designed as a camera. Alternatively or in addition, the observation device may include one or multiple sensors such as, for example, radar. The modeling of the surroundings may be carried out, for example, with the aid of an evaluation algorithm. In other words, the data generated by the observation device may be evaluated with the aid of an algorithm, as a result of which, in particular, the surroundings of the ascertainment device are able to be modeled. Modeling may, for example, mean a simulation of the surroundings.

The observation and modeling of the surroundings of the local ascertainment device may be carried out, in particular, with the aid of a tracking system. Tracking systems are able to determine, in particular, a position of objects, in particular, in a defined area. For example, multiple cameras are able to register an object in space. The position of the object in the catchment area may be determined via triangulation from the direction of the object in the two camera images and from the exact position of the cameras relative to one another. The determination in this case may take place in visible light or in other wave ranges. Based on such measurements, it is possible to create a model of the surroundings.

In other words, surroundings of the local ascertainment device are, or the area covered by the stop pillar is, initially detected and modeled. This may take place, for example, with the aid of an optical camera or by placing marker objects at particular crucial points such as a curbside. In this way, it is possible to create a model of the stopping point area.

In a second step 24 of method 20, pieces of information of the vehicle are received, in particular, by the local ascertainment device via a wireless communication. For example, the pieces of information of the vehicle via a wireless communication may be pieces of information about a position and/or a route and/or a final destination and/or an identification of the vehicle. Additionally in second step 24 of method 20, pieces of information of the potential passenger are received via a wireless communication, in particular, by the local ascertainment device. For example, the pieces of information of the potential passenger may be received via a wireless communication from an electronic mobile device of the potential passenger. In one further development, the pieces of information of the potential passenger via a wireless communication from an electronic mobile device of the potential passenger may be pieces of information about a position and/or a route and/or a final destination and/or an identification of the potential passenger. The pieces of information may preferably be sent and/or received via the wireless communication between the ascertainment device and the vehicle and/or between the ascertainment device and the electronic mobile device of the potential passenger via WLAN.

If a passenger enters the area that is monitored with the aid of the local ascertainment device, thus the area in which the stop may be planned, then the electronic mobile device of the passenger is able to communicate with the local ascertainment device. In other words, the electronic mobile device of the passenger may log in at the local ascertainment device. This may take place, for example, via WLAN and/or via an app of a mobile service provider available to the vehicle. The exact position of the electronic mobile device may be ascertained, in particular, via triangulation by the local ascertainment device. In this case, a signal strength or antennas with directivity may be used for position determination. The same process may take place involving the vehicle. Here, for example, the smartphone of the rideshare driver, a box of the mobility provider, a device in the vehicle or an autonomous vehicle itself may function as a communication partner. The assignment of passenger and vehicle may take place, in particular, via the mobility service.

In one further development, in order to better plan ahead, the expected arrival time of the partner in the stopping point area may be conveyed to the stop pillar already prior to the spatial detection. In one further development, a WLAN connection to the vehicle may be utilized in order to affordably download or upload data from the vehicle during the time in the stopping point area.

In a third step 26 of method 20, a position of the stopping area for the vehicle and for the potential passenger of the vehicle is ascertained as a function of the surroundings of the local ascertainment device and of the pieces of information of the vehicle and of the pieces of information of the potential passenger. To ascertain the position of the stopping area, multiple criteria, in particular, may be applied. For example, the distance of the passenger and of the vehicle relative to one another may be evaluated as well as their speeds. Open spots in the surroundings may further be ascertained with the aid of the observation device of the ascertainment device. For example, an open spot may be designed as a parking space, or as a bus stop or as a taxi stop. This may make it easier for the potential passenger to enter and exit the vehicle. In one further development, predefined areas may also be established, which may be used as a stopping area.

In other words, the local ascertainment device or the stop pillar plans the optimal locations and sequences of pickup areas based on all instantaneously registered users, in particular, on the potential passenger and on the vehicle and their positions, and conveys these positions to the users.

In a fourth step 28 of method 20, the position of the stopping area is conveyed to the vehicle and to the electronic mobile device of the potential passenger. The ascertained position may be sent and/or received preferably via the wireless communication between the ascertainment device and the vehicle and/or between the ascertainment device and the electronic mobile device of the potential passenger.

With the aid of method 20, it is possible to establish a virtual pickup location within a defined stopping point area and to guide vehicle and passenger to this location. With the aid of the local ascertainment device, which may also be referred to as a stop pillar, it is possible to spatially detect the physical environment, the vehicle and the electronic mobile device, for example, a smartphone, of the passenger. The stop pillar further conveys the information about the stopping area or pickup location to the parties involved. A program in the vehicle or electronic mobile device is able to represent the virtual pickup location, in which it superimposes this area, for example, via augmented reality, onto the camera image.

With the aid of the method, it is possible to detect, in particular, local physical structures, for example, objects, buildings and/or a sidewalk edge on the one hand, as well as mobile electronic units with wireless connection, such as portable electronic devices, for example, smartphones or electronic glasses, correspondingly equipped vehicles, for example, with a communication unit or autonomously acting robots, for example, self-driving autos, simultaneously in a shared coordinate system via a local ascertainment device. This information may then be used for planning the optimal pickup location for numerous pickups occurring simultaneously or in rapid succession.

In one further development, it is possible with the aid of a vehicle to transport multiple passengers. For example, it is possible with the aid of the local ascertainment device or further local ascertainment devices to ascertain stops for potential passengers in a defined order. In this way, the potential passengers are able to enter at optimal stops in succession or simultaneously.

In one further development, autonomously driving vehicles may be brought or driven as navigators directly from the stop pillar to their final destination or pieces of information necessary for such purpose such as, for example a layout and/or other road users, may be conveyed.

In one exemplary specific embodiment, defined pickup locations may be specified, the defined pickup locations being capable, in particular, of being numbered consecutively. In the case of defined and numbered pickup locations, the number may be conveyed to the vehicle or to the driver of the vehicle and to the potential passenger.

In one further development, a bus station may be operated with the aid of method 20 with no fixed stopping points. In one exemplary embodiment, autonomously moving units such as pieces of luggage or robots, in addition or alternatively to the passengers, may be coordinated with the system.

Passengers and vehicles may further be informed that their partner is directly in front of them and the authentication process may thus be shortened or bypassed. In one further development, vehicles in the stopping point area that do not register may be photographed and penalized with a fine, in particular, due to incorrect parking. In one exemplary embodiment, open stopping areas may further be auctioned.

FIG. 2 schematically shows a representation of a method 20 for ascertaining a position of a stopping area for a vehicle and for a potential passenger of the vehicle as a meeting point of the vehicle with the potential passenger according to one exemplary embodiment of the present invention. Method 20 may be carried out with the aid of a local ascertainment device, in particular, according to the local ascertainment device according to FIG. 3. Method 20 according to FIG. 2 may include the steps according to method 20 according to FIG. 1. Method 20 according FIG. 2 may further include a further fifth step 30. In fifth step 30 of method 20, the ascertained stop is represented. For example, the ascertained stop may be represented as an image with the aid of a display device of the local ascertainment device. For this purpose, the display device of the local ascertainment device may project, for example, a corresponding image on a surface in the surroundings of the local ascertainment device. For example, the display device may be designed for this purpose as a projection device. In other words, the pickup area may be projected from the stop pillar directly onto the ground. Furthermore, vehicle and rider may be directed to their pickup area via a defined color or a specific symbol.

In one further development, the ascertained stop may be represented as an image and/or as a virtual display and/or as navigation directions to the ascertained stop with the aid of a display device of the vehicle for a driver of the vehicle. The display device may be designed, for example, as a display device in the vehicle, for example, as a display, in particular, in an instrument cluster of the vehicle, as a projection device and/or as a head-up display. The driver may be preferably guided to the ascertained stop with the aid of navigation directions.

If the destination area is still too far away and thus would not be visible or only barely visible in the camera image, a navigation instruction may be used, for example, by navigation directions, for example, left, right, straight ahead, in order to first arrive in the immediate area of the destination.

In one further development, the ascertained stop may be represented as an image and/or as a virtual display and/or as navigation directions to the ascertained stop with the aid of a display device of the electronic mobile device of the potential passenger. For example, the stop may be represented in a map, which is displayed on the electronic mobile device or on a display of the electronic mobile device. The potential passenger may preferably be guided to the ascertained stop with the aid of navigation directions.

An application on the electronic mobile device or on the smartphone, in particular, a smartphone app of the passenger and in one further development also an app of the driver or of the vehicle may preferably utilize one or multiple linear and rotation acceleration sensors of the smartphone or of the vehicle as well as the direction of the stop pillar signal, in order to determine the orientation of the smartphone or of the vehicle in space. Together with the position of the pickup area, the projection of the area in the camera image may now be calculated and may be superimposed onto the image of the smartphone or of the display device of the vehicle. The continuous conveyance of the position of the area from the stop pillar enables, in particular, a constant dissolve even in a moving smartphone or vehicle. The passenger and/or the vehicle is/are only able to move into this area.

FIG. 3 schematically shows a representation of a system 32 according to one exemplary embodiment of the present invention. System 32 is designed to ascertain a position of a stopping area 34 for a vehicle 36 and for a potential passenger 38 of vehicle 36 as a meeting point of vehicle 36 with potential passenger 38. The system includes a local ascertainment device 40, a device 42, in particular, in vehicle 36, and an electronic mobile device 44. Electronic mobile device 44 may belong, in particular, to potential passenger 38.

Local ascertainment device 40 may be configured, in particular, to carry out a method according to the method according to FIG. 2 and/or according to FIG. 3. Local ascertainment device 40 preferably includes an observation device 46. Observation device 46 may include, for example, a camera or may be designed as a camera. Alternatively or in addition, observation device 46 may include one or multiple sensors such as, for example, radar. With the aid of observation device 46, it is possible, for example, to observe surroundings 48 of local ascertainment device 40. The ascertained data of the observation device may be used, for example, as a basis for a modeling or simulation of surroundings of local ascertainment device 40.

Local ascertainment device 40 may further include a transceiver device 50. With the aid of transceiver device 50, it is possible to receive and send, in particular, data. For example, data may be received from vehicle 36 and/or from potential passenger 38 or from mobile terminal 44 of potential passenger 38. For example, pieces of information of the vehicle via a wireless communication, pieces of information about a position and/or a route and/or a final destination and/or an identification of the vehicle may be received with the aid of transceiver device 50. In one further development, pieces of information of potential passenger 38 via a wireless communication from an electronic mobile device 44 of potential passenger 38, pieces of information about a position and/or a route and/or a final destination and/or an identification of potential passenger 38 may be received with the aid of transceiver device 50. Pieces of information about the wireless communication between ascertainment device 40 and vehicle 36 and/or between ascertainment device 40 and electronic mobile device 44 of potential passenger 38 may preferably be sent and/or received via WLAN.

One or multiple of the following processes may preferably be carried out with the aid of local ascertainment device 40. With the aid of local ascertainment device 40, it is possible to carry out a modeling of the physical environment and/or a registration and triangulation of the smartphone of the passenger and/or a registration and triangulation of the vehicle and/or an optimization of the space allocation or of the stopping area and/or a conveyance of the pickup area to vehicle and passenger.

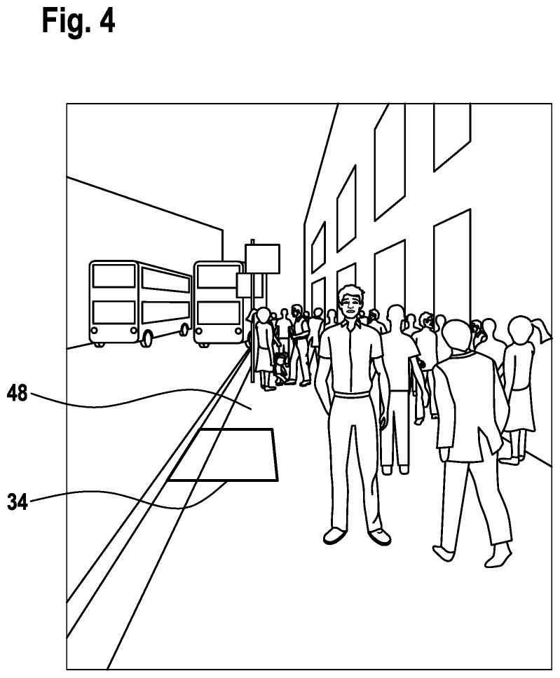

The received data may be evaluated, in particular, with the aid of local ascertainment device 40, for example, with the aid of a processing unit on local ascertainment device 40. A position of a stopping area 34 may be ascertained by the evaluation of the data. A position of a stopping area may be, in particular, the location at which vehicle 36 meets with potential passenger 38. In this way, potential passenger 38 is able to enter vehicle 36 to be transported with the aid of vehicle 36 to the desired final destination. In one further development, ascertained stopping area 34 may be represented, for example, by a display device, for example, by a projection device of local ascertainment device 40. Ascertained stopping area 34 may, for example, be projected onto a corresponding surface in the surroundings of local ascertainment device 40. For example, stopping area 34 may be represented according to stopping area 34 according to FIG. 4.

Stopping area 34 may be represented as a cohesive area. Alternatively, as in this advantageous embodiment, stopping area may be divided into two subareas. A first subarea is intended for potential passenger 38 and a second subarea is intended for vehicle 36. Passenger 38 may move according to the arrow in the direction of the first subarea. Vehicle 36 may move according to the arrow in the direction of the second subarea.

Device 42 is situated, in particular, in or at vehicle 36. Device 42 sends pieces of information of vehicle 36 via a wireless communication to local ascertainment device 40. Device 42 further receives pieces of information from local ascertainment device 40 about a position of a stopping area 34 for vehicle 36 and about a potential passenger 38 of vehicle 36 as a meeting point of vehicle 36 with potential passenger 38. In one further development, device 42 may include a display unit, the display unit being designed to represent ascertained stopping area 34 as an image and/or ascertained stopping area 34 as a virtual display and/or navigation directions to ascertained stopping area 34 of vehicle 36 for a driver of vehicle 36. In other words, the display unit may represent a position of stopping area 34, in particular for the driver of vehicle 36, in such a way that the driver of vehicle 36 is directed to stopping area 34. Alternatively, stopping area 34 may also be represented for potential passenger 38, so that the potential passenger and vehicle 36 meet. For example, stopping area 34 may be represented according to stopping area 34 according FIG. 4.

Electronic mobile device 44 may be, in particular, an electronic mobile device 44 of potential passenger 38 of vehicle 36. Electronic mobile device 44 may be designed, for example, as a smartphone or augmented reality glasses. Electronic mobile device 44 sends pieces of information of potential passenger 38 via a wireless communication to a local ascertainment device 40. Mobile device 44 further receives pieces of information from local ascertainment device 40 about a position of stopping area 34 for vehicle 36 and for potential passenger 38 of vehicle 36 as a meeting point of vehicle 36 with potential passenger 38. In one further development, electronic mobile device 44 may include a display unit, the display unit being designed to represent ascertained stopping area 34 as an image and/or ascertained stopping area 34 as a virtual display and/or navigation directions to ascertained stopping area 34 for potential passenger 38 of vehicle 36. The display unit may, for example, show the display of a smartphone as electronic mobile device 44. In other words, the display unit may show a position of stopping area 34, in particular, for potential passenger 38 of a vehicle, in such a way that potential passenger 38 is directed to stopping area 34. For example, stopping area 34 may be represented according to stopping area 34 according to FIG. 4.

One or both of the following processes may be advantageously carried out with the aid of electronic mobile device 44. With the aid of electronic mobile device 44, it is possible, in particular, to receive a position of the destination area or stopping area and/or the stopping area may be superimposed onto the camera image.

With the aid of augmented reality glasses, it is possible to superimpose virtual contents onto the visible environment, as a result of which the environment may thus be expanded. In order to establish an ego-position relative to the environment, particularly during movements, these glasses are able to use the outside-in tracking or else the inside-out tracking. During inside-out tracking, a camera in the glasses tracks the movement of static objects in the camera image and calculates therefrom the ego-motion of the camera or of the glasses. In addition, these glasses are able to recognize surfaces in the environment, onto which virtual objects may be placed, whose instantaneous perspective view is continuously updated with the aid of the movement of the glasses. The virtual object thus appears to remain static in the environment. For this purpose, areas may be searched, in particular during movements of the camera, which carry out connected movements and accordingly may be assigned to connected objects. By linking a change of position of these areas in the image to acceleration data of the device, which also contains the camera, a 3D model of the surroundings may thus be created.

FIG. 4 schematically shows a representation of a stopping area 34 according to one exemplary embodiment of the present invention. Stopping area 34 may be ascertained, for example, with the aid of the method according to the method according to FIG. 1 and/or according to FIG. 2. Stopping area 34 may further be designed according to the stopping area according to FIG. 3.

In this advantageous embodiment, stopping area 34 is situated in surroundings 48. Stopping area 34 is projected, in particular, as a rectangular frame onto the ground. Stopping area 34 is preferably the area in which the potential passenger meets the vehicle and, in particular, enters the vehicle.

1-15. (canceled)

16. A method for ascertaining using a local ascertainment device a position of a stopping area for a vehicle and for a potential passenger of the vehicle as a meeting point of the vehicle with the potential passenger, including the following steps,
observing and modeling surroundings of the local ascertainment device;
receiving pieces of information of the vehicle via a wireless communication,
receiving pieces of information of the potential passenger via a wireless communication, from an electronic mobile device of the potential passenger;
ascertaining a position of the stopping area for the vehicle and for the potential passenger of the vehicle as a function of the surroundings of the local ascertainment device, of the pieces of information of the vehicle, and of the pieces of information of the potential passenger; and
conveying the position of the stopping area to the vehicle and to the electronic mobile device of the potential passenger.

17. The method as recited in claim 16, wherein the step of observing and modeling the surroundings of the local ascertainment device is carried out with the aid of using an observation device of the local ascertainment device.

18. The method as recited in claim 17, wherein the observation device is a camera.

19. The method as recited in claim 16, further comprising representing the ascertained stopping area as an image using a display device of the local ascertainment device.

20. The method as recited in claim 16, further comprising representing, using a display device of the vehicle for a driver of the vehicle, the ascertained stopping area as an image and/or the ascertained stopping area as a virtual display and/or navigation directions to the ascertained stopping area.

21. The method as recited in claim 16, further comprising representing, using a display device of the electronic mobile device of the potential passenger, the ascertained stopping area as an image and/or the ascertained stopping area as a virtual display and/or navigation directions to the ascertained stopping area.

22. The method as recited in claim 16, wherein in the step of receiving pieces of information of the vehicle via a wireless communication, pieces of information about a position of the vehicle and/or a route of the vehicle and/or a final destination of the vehicle and/or an identification of the vehicle, are received.

23. The method as recited in claim 16, wherein in the step of receiving pieces of information of the potential passenger via a wireless communication from the electronic mobile device of the potential passenger, pieces of information about a position of the potential passenger and/or a route of the potential passenger and/or a final destination of the potential passenger and/or an identification of the potential passenger, are received.

24. The method as recited in claim 16, wherein pieces of information are sent and/or received via WLAN about the wireless communication between the local ascertainment device and the vehicle and/or between the local ascertainment device and the electronic mobile device of the potential passenger.

25. A local ascertainment device for ascertaining using a local ascertainment device a position of a stopping area for a vehicle and for a potential passenger of the vehicle as a meeting point of the vehicle with the potential passenger, the local ascertainment device configured to:
observe and model surroundings of the local ascertainment device;
receive pieces of information of the vehicle via a wireless communication,
receive pieces of information of the potential passenger via a wireless communication, from an electronic mobile device of the potential passenger;
ascertain a position of the stopping area for the vehicle and for the potential passenger of the vehicle as a function of the surroundings of the local ascertainment device, of the pieces of information of the vehicle, and of the pieces of information of the potential passenger; and
convey the position of the stopping area to the vehicle and to the electronic mobile device of the potential passenger.

26. A device in a vehicle, the device configured to send pieces of information of the vehicle via a wireless communication to a local ascertainment device, receive pieces of information from the local ascertainment device about a position of a stopping area for the vehicle and about a potential passenger of the vehicle as a meeting point of the vehicle with the potential passenger.

27. The device as recited in claim 26, wherein the local ascertainment device is configured to:
observe and model surroundings of the local ascertainment device;
receive the pieces of information of the vehicle via a wireless communication,
receive pieces of information of the potential passenger via a wireless communication, from an electronic mobile device of the potential passenger;
ascertain the position of the stopping area for the vehicle and for the potential passenger of the vehicle as a function of the surroundings of the local ascertainment device, of the pieces of information of the vehicle, and of the pieces of information of the potential passenger; and
convey the position of the stopping area to the vehicle and to the electronic mobile device of the potential passenger.

28. The device as recited in claim 26, wherein the device includes a display unit, the display unit being configured to represent the ascertained stopping area as an image and/or the ascertained stopping area as a virtual display and/or navigation directions to the ascertained stopping area, for a driver of the vehicle.

29. An electronic mobile device of a potential passenger of a vehicle, the electronic mobile device configured to send pieces of information of the potential passenger via a wireless communication to a local ascertainment device, the electronic mobile device configured to receive pieces of information from the local ascertainment device about a position of a stopping area for the vehicle and for the potential passenger of the vehicle as a meeting point of the vehicle with the potential passenger.

30. The electronic mobile device as recited in claim 29, wherein the wherein the local ascertainment device is configured to:
observe and model surroundings of the local ascertainment device;
receive pieces of information of the vehicle via a wireless communication, receive the pieces of information of the potential passenger via a wireless communication, from the electronic mobile device of the potential passenger;
ascertain the position of the stopping area for the vehicle and for the potential passenger of the vehicle as a function of the surroundings of the local ascertainment device, of the pieces of information of the vehicle, and of the pieces of information of the potential passenger; and
convey the position of the stopping area to the vehicle and to the electronic mobile device of the potential passenger

31. The electronic mobile device as recited in claim 29, wherein the electronic mobile device includes a display unit, the display unit being configured to represent the ascertained stopping area as an image and/or the ascertained stopping area as a virtual display and/or navigation directions to the ascertained stopping area for the potential passenger of the vehicle.

32. A system for ascertaining a position of a stopping area for a vehicle and for a potential passenger of the vehicle as a meeting point of the vehicle with the potential passenger, the system comprising:
a local ascertainment device configured to:
observe and model surroundings of the local ascertainment device;
receive pieces of information of the vehicle via a wireless communication,
receive pieces of information of the potential passenger via a wireless communication, from an electronic mobile device of the potential passenger,
ascertain a position of the stopping area for the vehicle and for the potential passenger of the vehicle as a function of the surroundings of the local ascertainment device, of the pieces of information of the vehicle, and of the pieces of information of the potential passenger, and
convey the position of the stopping area to the vehicle and to the electronic mobile device of the potential passenger;
a device in a vehicle, the device configured to send the pieces of information of the vehicle via a wireless communication to the local ascertainment device, receive pieces of information from the local ascertainment device about the position of the stopping area for the vehicle and about the potential passenger of the vehicle as the meeting point of the vehicle with the potential passenger; and
the electronic mobile device of the potential passenger of the vehicle, the electronic mobile device configured to send the pieces of information of the potential passenger via a wireless communication to the local ascertainment device, the electronic mobile device configured to receive pieces of information from the local ascertainment device about the position of the stopping area for the vehicle and for the potential passenger of the vehicle as the meeting point of the vehicle with the potential passenger.
